(19) United States
(12) Patent Application Publication
(10) Pub. No.: US 2007/0188061 A1
(43) Pub. Date: Aug. 16, 2007

(54) High intensity discharge arc tubes with glass heat shields

(76) Inventor: Huiling Zhu, Lexington, MA (US)

Correspondence Address: GREGORY A. STOBBS, 5445 CORPORATE DRIVE, SUITE 400, TROY, MI, 48098, US

(21) Appl. No.: 11/354,760

(22) Filed: Feb. 15, 2006

(51) Int. Cl. H01J 61/52

(52) U.S. Cl. 313/46

(57) ABSTRACT

A high intensity discharge lamp is provided with an arc tube having an improved heat insulator. The heat insulator is formed proximate to at least one end of the arc tube but absent around an outer middle portion of the arc tube. In addition, the heat insulator is made of a material transmissive of visible light but not transmissive of thermal radiation. By adding a heat insulator to the cold spot area of the arc tube, radiation heat lose from that area will be significantly reduced and the temperature of that area will be increased. Moreover, by choosing a material that will not get oxidized and will not block the visible light, higher lamp efficacy can be achieved.

### FIELD

The present disclosure relates to high intensity discharge lamps and, more particularly, to a discharge lamp configured with heat insulators at either ends of the arc tube.

### BACKGROUND

Due to the ever-increasing interest in energy conserving lighting systems, metal halide lamps with higher and higher lamp efficacy are desired. Besides the optimization of metal halide fill chemistry in the arc tube, thermal control of the arc tube is also important. For metal halide lamps, the lamp performance is directly related to the vapor pressure of metal halide fill at normal working condition. The cold spot temperature of the arc tube controls the vapor pressures of the metal halide fills. The higher the cold spot temperature the higher the vapor pressures of the metal halide fills inside the arc tube. With higher vapor pressure the lamps can have better performance with higher lamp efficacy and better color rendering properties. Usually the cold spot is located behind the arc tube electrodes at the two ends of an arc tube.

Therefore, it is desirable to provide a metal halide lamp with higher cold spot temperatures in such a way that the maximum temperature of the arc tube will not exceed the limit of working temperature of the arc tube material. The metal halide vapor pressures inside the arc tube should be increased at a given wattage, thereby improving lamp efficacy and color performance. In addition, the cold spot temperatures of an arc tube should be increased without blocking the visible light output produced by the arc tube so all the increase of efficacy due to higher cold spot temperature can be transported outside of the lamp. The statements in this section merely provide background information related to the present disclosure and may not constitute prior art.

### SUMMARY

A high intensity discharge lamp is provided with an arc tube having an improved heat insulator. The heat insulator is formed proximate to at least one end of the arc tube but absent around an outer middle portion of the arc tube. In addition, the heat insulator is made of a material transmissive of visible light but not transmissive of thermal radiation. By adding a heat insulator to the cold spot area of the arc tube, radiation heat lose from that area will be significantly reduced and the temperature in that area will be increased. Moreover, by choosing a material that will not get oxidized and will not block the visible light, higher lamp efficacy can be achieved.

Further areas of applicability will become apparent from the description provided herein. It should be understood that the description and specific examples are intended for purposes of illustration only and are not intended to limit the scope of the present disclosure.

### DRAWINGS

FIG. 1 is a cross-sectional view of an exemplary embodiment of a high intensity discharge lamp having heat insulators in accordance with the present disclosure;

FIG. 2 is a fragmentary cross-sectional view of the discharge lamp;

FIG. 3A is a cross-sectional view of a high intensity discharge lamp having another exemplary embodiment of heat insulators;

FIG. 3B is a cross-sectional view of the capillary portion of the arc tube taken along line A-A′ of FIG. 3A; and

FIG. 4 is a cross-sectional view of a high intensity discharge lamp having yet another exemplary embodiment of heat insulators.

The drawings described herein are for illustration purposes only and are not intended to limit the scope of the present disclosure in any way.

### DETAILED DESCRIPTION

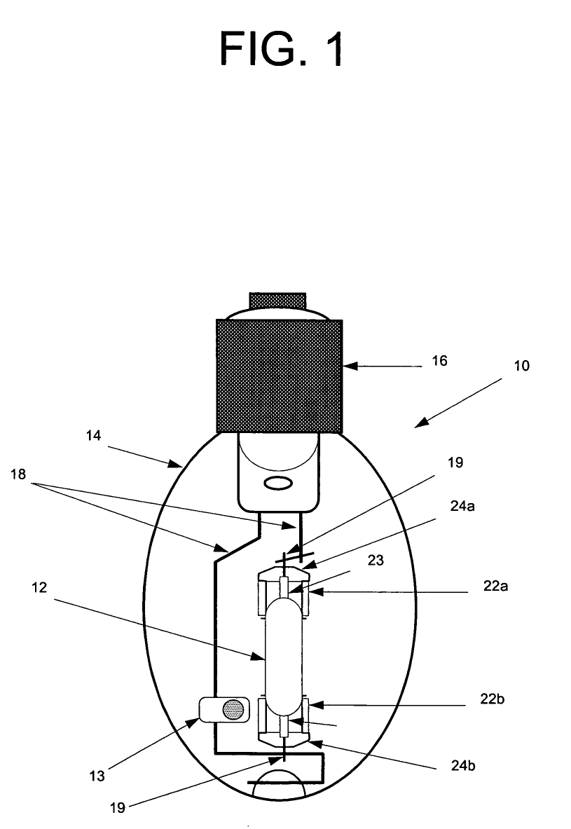

FIG. 1 illustrates an exemplary high intensity discharge lamp 10. The lamp 10 is generally comprised of an arc tube 12 having an elongated shape disposed in an outer envelope 14. The arc tube 12 defines an enclosed discharge space which contains ionizable materials, such as metal halides and mercury, and a starting gas, such as argon or xenon. It is understood that other materials may be sealed in the arc tube. Likewise, it is understood that other shapes for the arc tube as well as for the outer envelope are within the scope of this disclosure.

An end cap 16 is provided at one end of the outer envelope. A pair of lead wires 18 extends from the end cap 16 and into the inner cavity formed by the outer envelope 14. The pair of lead wires 18 in turn electrically connects to current feedthrough members 19 at each end of the arc tube 12. A getter 13 for trapping impurity gases may be welded to one of the lead wires.

A cylindrical electrode sleeve 23 (also referred to as a capillary tube) extends longitudinally outward from each end of the arc tube. Each cylindrical electrode sleeve 23 provides a through hole for a current feedthrough member 19 to extend from outside of the arc tube into an inner cavity of the arc tube. To seal the inner cavity of the arc tube, a sealing frit is placed into the end of the electrode sleeve 23 to fill any gap around the current feedthrough member 19. While a basic construction for the discharge lamp has been discussed above, it is readily understood that variations from this design are contemplated by this disclosure.

Typically, the cold spot in a high intensity discharge lamp is located at the ends of the arc tube or at the capillary portion of the arc tube. Due to the location of the thermal discharge, the ends of the arc tube and its capillaries are cooler so that salt additives condense at this location. If the temperature of this location can be raised by collecting and reradiating the thermal energy loss from the hot current feedthrough members, lamp additive vapor pressure will increase inside the arc tube producing better performance. By adding a heat insulator to the cold spot area, radiation heat lose from that area will be significantly reduced and the temperature of that area will be increased. Moreover, by choosing a material that will not get oxidized (e.g., metal) due to lamp process conditions and will not block the visible light, higher lamp efficacy can be achieved. Accordingly, this disclosure employs a heat insulator made of a material which is highly transmissive in the visible light region, but not transmissive of infrared thermal radiation. While the following description is provided with reference to quartz, it is understood that other materials, such as aluminosilicate or borosilicate, may also be used for the heat insulator.

In one exemplary embodiment, two straight quartz tubes 22A, 22B are employed as heat insulators as shown in FIG. 1. The two quartz tubes may be held in place by a pair of metal wire clips 24a, 24b which are welded to the portion of the current feedthrough member 19 that is outside of the arc tube 12. The two quartz tubes 22A, 22B have an inner diameter slightly larger than the outer diameter of the arc tube 12. In this way, the two quartz tubes 22A, 22B encircle each end of the arc tube 12, thereby increasing the cold spot temperature by reflection, absorption and reemission of thermal radiation. Since there is no heat insulator encircling the center portion of the arc tube, the temperature at the center of the arc tube will not be increased. It is noteworthy that the manufacturing cost of a straight quartz tube is relatively inexpensive.

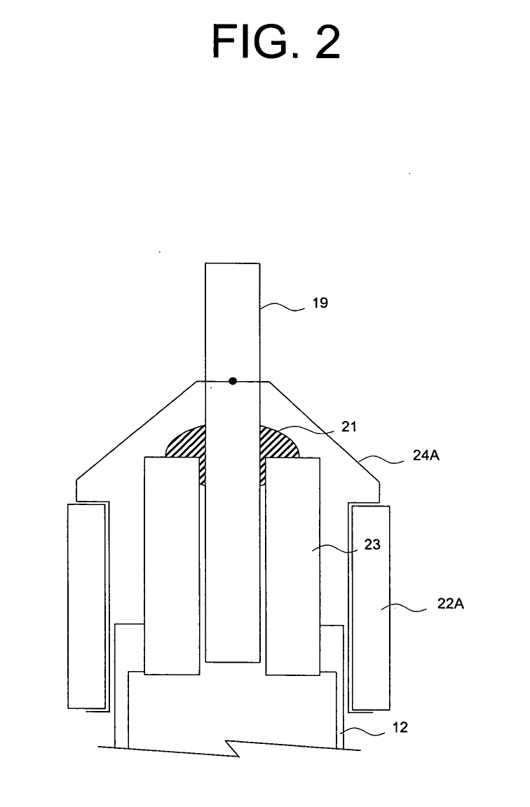

In another aspect of this embodiment, the heat insulators preferably do not encircle the entire capillary portion of the arc tube. With reference to FIG. 2, the heat insulator 22A is preferably not adjacent to where the sealing frit 21 occurs within the electrode sleeve 23 so that the temperature in this area will not be increased. Maintaining relatively lower temperatures proximate to the seal frit will limit any chemical reactions which may occur between the metal halide fill and the sealing material, thereby facilitating longer lamp life.

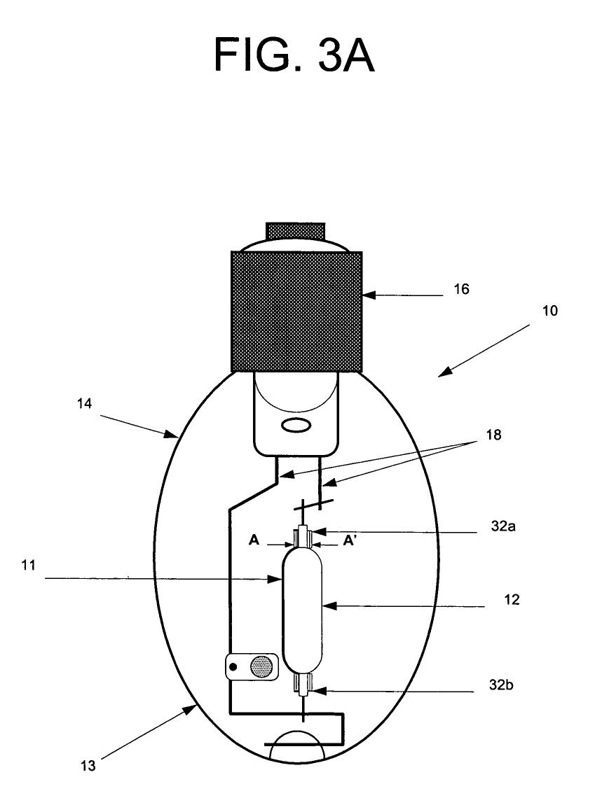

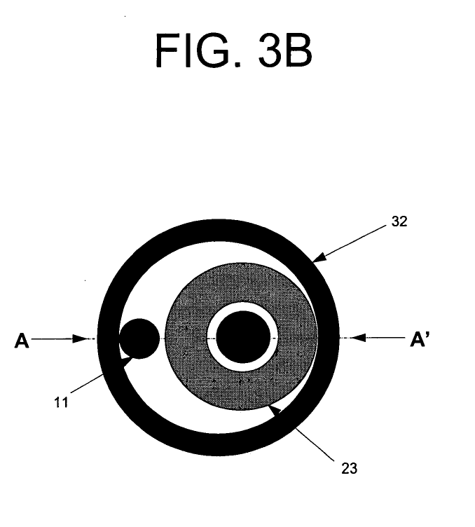

FIGS. 3A and 3B illustrates another exemplary embodiment of a discharge lamp 10 having a heat insulator in accordance with the present disclosure. In this embodiment, the heat insulators 32A, 32B are sized to encircle only the capillary portion of the arc tube. With reference to FIG. 3B, the heat insulators 32A, 32B are a loose fit around the capillary portion of the arc tube. A metal wire 11 made be used to hold the heat insulators 32A, 32B in place. In an exemplary embodiment, the wire follows the outer contour of the arc tube and is formed into a hook shape at each end. However, it is envisioned that other mechanism may be used to hold the heat insulators in place.

As above, the heat insulators 32A, 32B are made of a material which is highly transmissive in the visible light region, but not transmissive of infrared thermal radiation. In addition, the heat insulators 32A, 32B preferably do not extend to the end of the capillary portion and thus are not adjacent to where the sealing frit 21 occurs within the electrode sleeve 23. This structure will increase the temperature of the metal halide chemicals inside the capillary, thereby enabling the metal halide lamps to be designed with lower amount of metal halide chemical fill inside the arc tube. Lower metal halide chemical fill will reduce the impurity inside the arc tube and will also reduce the chemical reactions inside the arc tube between the metal halide fill and the arc tube wall material.

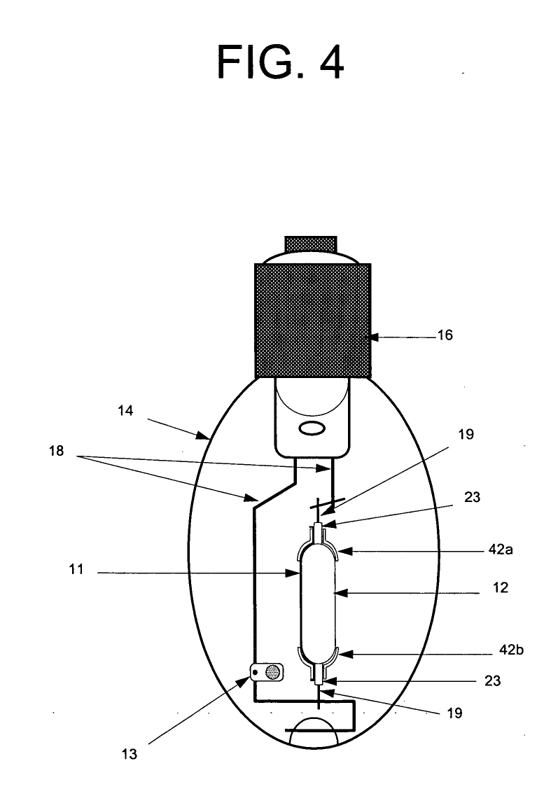

FIG. 4 illustrates yet another exemplary embodiment of a discharge lamp having a heat insulator in accordance with the present disclosure. In this embodiment, each heat insulator 42A, 42B is comprised of an open-ended cylinder having a flared portion at one end. The inner diameter of the cylinder is again sized to encircle the capillary portion of the arc tube. In addition the cylinder is not adjacent to the area of the capillary where the sealing frit exists. The inner surface of the flared portion is contoured to mimic the outer surface of the end of the arc tube. As above, a metal wire 11 made be used to hold the heat insulators 42A, 42B in place. Although not necessary, it is preferable that the heat insulator 22A be spatially separated from the outer surface of the arc tube, thereby avoiding conductive heat transfer away from the arc tube.

With the application of heat insulators to the two ends of an arc tube, the temperature difference between the maximum temperature of the arc tube and the cold spot temperature of the arc tube can be reduced so that the distribution of operating temperature over the body of the arc tube is more isothermal. There are desirable benefits derived from the more isothermal operation of the arc tube. Usually most lamp characteristics, such as luminous efficacy and color performance, improve significantly with higher cold spot temperature without increase in the maximum temperature. Most metal halide lamps have their maximum temperatures very close to the limit of the arc tube materials for good maintenance and long life. Further increase the maximum temperature will reduce the lamp life. For a fixed maximum arc tube temperature, a relatively higher cold spot temperature will improve color rendition because more of the metal halide additive is in the vapor phase. Also the reduction of the maximum arc tube temperature will reduce the chemical reaction between the metal halide additives and the alumina arc tube body. Because the temperature differentials are reduced, thermal stresses within the arc tube wall will be reduced. This will eliminate the cracking failure of alumina arc tubes during lamp life due to the thermal stress.

Experimental data also proved the effect of such heat insulators. In the table below, photometric data of two ceramic metal halide lamps with different arc tube geometries and chemical fills are presented with and without the quartz heat insulators.

| | | | | Relative | | | | |
|---|---|---|---|---|---|---|---|---|
| Lamp | Hour | W | V | LPW | CCT | CRI | T-cold | T-max |
| #1 no quartz shield | 100 | 150 | 101 | 1.00 | 3067 | 54 | 978 | 1104 |
| #1 with quartz shield | 105 | 150 | 106 | 1.04 | 3255 | 59 | 1040 | 1115 |
| #2 no quartz shield | 100 | 150 | 103 | 1.00 | 4141 | 66 | 951 | 1085 |
| #2 with quartz shield | 105 | 150 | 110 | 1.03 | 4068 | 67 | 1019 | 1074 |

Arc tube wall temperature measurement using infrared imaging techniques shows that with the quartz heat insulators the arc tube has more uniform temperature with reduced maximum temperature near the center of the arc tube and increased minimum temperature near the capillaries. With a more isothermal arc tube, the metal halide lamp will have better performance at different orientations. In addition, there is significant lamp efficacy increase when the quartz heat shield is applied to the arc tube of the lamps. Color rendering indexes of the two lamps are also improved. These improvements of lamp performance are due to the higher cold spot temperatures that will lead to higher metal halide vapor pressure inside the arc tubes.

The description of the invention is merely exemplary in nature and, thus, variations that do not depart from the gist of the invention are intended to be within the scope of the invention. Such variations are not to be regarded as a departure from the spirit and scope of the invention. It should be understood that throughout the drawings, corresponding reference numerals indicate like or corresponding parts and features.

What is claimed is:

1. A high intensity discharge lamp, comprising:
an outer envelope;
an arc tube having an elongated shape disposed in the outer envelope; and
a heat insulator formed proximate to at least one end of the arc tube but absent around an outer middle portion of the arc tube, the heat insulator made of a material transmissive of visible light and non-transmissive of thermal radiation.

2. The high intensity discharge lamp of claim 1 wherein the heat insulator is in the shape of an open-ended cylinder.

3. The high intensity discharge lamp of claim 1 wherein heat insulator having an inner surface contour that substantially mimics an outer surface contour of the end of the arc tube.

4. The high intensity discharge lamp of claim 1 wherein heat insulator is spatially separated from an outer surface of the arc tube.

5. The high intensity discharge lamp of claim 1 further comprises an electrode extending longitudinally from the end of the arc tube; and a clip welded to the electrode and configured to hold the heat insulator proximate to the end of the arc tube.

6. The high intensity discharge lamp of claim 1 wherein a heat insulator is formed proximate to each end of the arc tube.

7. The high intensity discharge lamp of claim 1 wherein the material of the heat insulator is substantially silicon oxide.

8. The high intensity discharge lamp of claim 1 wherein the material of the heat insulator is substantially aluminosilicate or substantially borosilicate.

9. The high intensity discharge lamp of claim 1 further comprises a cylindrical electrode sleeve extending longitudinally from each end of the arc tube, the electrode sleeves having an outer diameter smaller than an outer diameter of the arc tube and the heat insulator being formed only adjacent to an outer surface of the electrode sleeve.

10. The high intensity discharge lamp of claim 9 wherein the electrode sleeves provide a through hole therein for an electrode which extends from outside of the arc tube into an inner cavity of the arc tube, such that a sealing substance is disposed into an exterior facing end of the through hole and the heat insulator does not extend around the electrode sleeve in an area adjacent to the sealing substance.

11. A high intensity discharge lamp, comprising:
an outer envelope;
an arc tube having an elongated shape disposed inside the outer envelope;
an electrode sleeve extending longitudinally from each end of the arc tube, wherein each electrode sleeve defines a through hole therein for an electrode which extends from outside of the arc tube into an inner cavity of the arc tube; and
a heat insulator formed adjacent only to an outer surface of the electrode sleeve, the heat insulator made of a material transmissive of visible light and non-transmissive of thermal radiation.

12. The high intensity discharge lamp of claim 11 wherein the heat insulator is in the form of an open-ended cylinder that encircles a portion of the electrode sleeve.

13. The high intensity discharge lamp of claim 12 wherein an inner diameter of the heat insulator is larger than the outer diameter of the electrode sleeve, such that the heat insulator is spatially separated from the electrode sleeve.

14. The high intensity discharge lamp of claim 11 wherein heat insulator does not encircle the electrode sleeve in an area adjacent to a sealing substance disposed into an exterior facing end of the through hole.

15. The high intensity discharge lamp of claim 11 wherein the heat insulator is made of silicon oxide, aluminosilicate or borosilicate.

16. The high intensity discharge lamp of claim 11 further comprises a means for holding the heat insulator in place along the outer surface of the electrode sleeve.

17. A high intensity discharge lamp, comprising:
an outer envelope;
an arc tube having an elongated shape disposed inside the outer envelope;
an electrode sleeve extending longitudinally from each end of the arc tube, wherein each electrode sleeve defines a through hole therein for an electrode which extends from outside of the arc tube into an inner cavity of the arc tube; and
a heat insulator encircles an outer surface of the electrode sleeve, but does not encircle the electrode sleeve in an area adjacent to a sealing substance disposed into an exterior facing end of the through hole.

18. The high intensity discharge lamp of claim 17 wherein the heat insulator is in the form of an open-ended cylinder that encircles a portion of the electrode sleeve.

19. The high intensity discharge lamp of claim 18 wherein an inner diameter of the heat insulator is larger than the outer diameter of the electrode sleeve, such that the heat insulator is spatially separated from the electrode sleeve.

20. The high intensity discharge lamp of claim 17 wherein the heat insulator is made of silicon oxide, aluminosilicate or borosilicate.

21. The high intensity discharge lamp of claim 17 further comprises a means for holding the heat insulator in place along the outer surface of the electrode sleeve.
